(19) United States
(12) Patent Application Publication
(10) Pub. No.: US 2001/0056467 A1
(43) Pub. Date: Dec. 27, 2001

(54) Information search and shopping system

(76) Inventor: William T. Wilkinson, Salem, NJ (US)

Correspondence Address: Ratner & Prestia, P.O. Box 7228, Wilmington, DE, 19803, US

(21) Appl. No.: 09/788,719

(22) Filed: Feb. 20, 2001

Related U.S. Application Data
(60) Provisional application No. 60/184,199, filed on Feb. 22, 2000.

(51) Int. Cl. G06F 15/16

(52) U.S. Cl. 709/204; 709/229

(57) ABSTRACT

A method for a user to conduct research on an information network. The user contacts a service provider having access to the information network; the user communicates information regarding a desired research project to the service provider; the service provider conducts the research on the information network and finds one or more or no results; and the service provider communicates the results or lack thereof to the user. The research project may comprise obtaining information about a goods or services, in which case the method may further comprise the user placing an order for the goods or services through the service provider and the service provider obtaining the goods or services for the user through the information network. A similar method may be used for soliciting customers for goods and services. The invention also comprises a system to enable a user to indirectly conduct research on an information network in accordance with the method.

### CROSS-REFERENCE TO RELATED APPLICATIONS

This application claims priority based upon Provisional Application Ser. No. 60/184,199, filed Feb. 22, 2000, and incorporated herein by reference.

### TECHNICAL FIELD

This invention relates to systems and methods for information research and shopping, and more specifically, information research and shopping on a global computer information network such as the Internet/World-Wide-Web.

### BACKGROUND OF THE INVENTION

Despite the technological advances provided by the global computer information network also known as the Internet/World-wide web, there are still some drawbacks to searching for information and shopping on the Internet. For example, some individuals may have no personal computer (PC), no Internet access or only limited Internet access. At certain times, it is difficult to get online or heavy traffic may be encountered on the Internet, especially during peak hours (such as business hours during the week). Some users may have little to no skill at conducting searches, making searching time-consuming and frustrating.

Additionally, some programs/software make searching for information and products difficult. The proliferation of web guides and search engines means that there are potentially many ways to search, each of which may provide different results. Furthermore, searches typically reveal massive amounts of subject information, making it difficult to sort out and process the information to find the desired results. The proliferation of billing information with increasing security risk is also of concern to many. Finally, it takes time, effort, and expense to search for information and products.

Thus, there is the need for a system and method that can simplify the search for information and products, speed up the search process, make searching easier, less time consuming, and less expensive, and complete the search for people too busy to perform the search themselves.

### SUMMARY OF THE INVENTION

The invention comprises a method for a user to indirectly conduct research on an information network. The method comprises the user contacting a service provider having access to the information network; the user communicating information regarding the desired research to the service provider; the service provider conducting the research on the information network and finding one or more results or no results; and the service provider communicating the results or lack of results to the user. The research project may comprise obtaining information about goods or services, in which case the method may further comprise the user placing an order for the goods or services through the service provider after being provided the results of the research; and the service provider obtaining the goods or services for the user through the information network. The user interface may comprise a human operator or a computerized interface, and the user may communicate the desired research project by responding to a menu of information requests.

The invention also comprises a method for a user to solicit customers for goods or services on an information network. The method comprises the steps of the user contacting a service provider having access to the information network; the user communicating information regarding the goods or services to the service provider; the service provider posting on the information network a solicitation for customers for the goods or services and receiving one or more or no responses to the solicitation; and the service provider communicating the responses or lack of responses to the user.

The invention also comprises a system to enable a user to indirectly conduct research on an information network. The system comprises a service provider having access to the information network; an interface with the service provider accessible to the user; a menu of one or more information requests communicable to the user by the service provider; means for receiving responses from the user to the menu of information requests; and means for notifying the user of results of the research. Where the research comprises shopping for goods or services, the system may further comprise means for accepting an order from the user for goods or services, means for placing the order with a third party, and means for arranging shipping or delivery of the goods or services.

### BRIEF DESCRIPTION OF DRAWINGS

FIG. 1 is a flowchart depicting an exemplary embodiment of the method of the invention.

### DETAILED DESCRIPTION OF INVENTION

The invention is primarily an information search system/process, but can also be used for shopping for or selling goods or services. As used herein the terms “goods or services” or “products or services” refer to any tangible or intangible object, singular or plural, offered for sale, rent, lease, etc., or service of any type offered in return for compensation of any type. The system eliminates the need for the user to use the net/web directly, or use portals/search engines. The system employs a third party—a service provider—to do the search, and can be viewed as the ultimate search engine. It solves all of the foregoing problems presently confronting the Internet user. It is composed of certain basic elements, as described below.

The system comprises means for a user to access the system. Preferably, the means are quick, easy, inexpensive, and readily available, such as a telephone, television (for example, tuned to a special channel that enables the user to interact either by a remote control unit or a telephone), interactive televisions with a remote control unit for inputting the data, computer, fax, mail, or electronic mail (e-mail).

The system also comprises a user interface, such as a human operator, or initial contact person/source to whom the user communicates the desired research. In other embodiments, the human operator may be optional, and the user may go directly to a master menu, such as a computerized menu. The system may comprises a master menu of information categories, and/or products or services, that helps to guide the user in placing an order for specific information and/or products or services, or posting information about products or services offered for sale, lease, rent, and the like.

The operator or other user interface may receive the customer information, information about the research desired or product or service desired or to be ordered, and/or information about a product or service desired to be offered by the user to others, such as purebred dogs, classic automobiles, sports memorabilia, and the like. Services that the user desires to order or offer to others may include any service, such as but not limited to, professional services, such as offered by doctors or lawyers. Criteria such as method of payment (credit cards, insurance companies, etc.), office hours and availability (such as night hours or weekend hours), credentials of the professionals, and the like, may be parameters used in the search.

Normally, the customer places his order with the operator/user interface of the service provider, and then disconnects from the service provider and waits for the order to be filled and delivered. The service provider may then search the desired information, and/or shop for the desired product or service, and deliver it or have it ordered and delivered, or post the information regarding the product or services offered by the user. A specialized researcher may receive the order from the operator/user interface, such as directly from the computerized menu, and then may search, shop, and locate the desired information and/or products or services. The researcher can also format the desired information per user specification.

A packer/shipper may package and ship/deliver the information and/or product to the user, and bill the user, or may package and ship/deliver the items sold by the user. The packer/shipper may be integral to the service provider, or may be a third party, such as the vendor of the goods or services contacted by the service provider through the computer network (i.e. the Internet).

The service provider may offer incentives for users to buy or sell goods or services through the service provider. For example, to reward users for ordering through the service provider's system, vendors or the service provider may give the user a product discount and/or bonus value points (such as frequent flier miles or the like) that can be redeemed for money (or other value).

The service provider may bill users based upon time spent working for that user at an hourly search rate or dependent upon the request. The provider may also charge for access/use of the services, and may assess formatting, packaging, copying and shipping charges. In certain circumstances, the user may not be billed or may receive a reduced bill for use of the services if the supplier of the goods or services ordered by the user pays a percentage of the cost in the form of a rebate. The service provider may also bill a percentage of the item sold, or a flat fee per item sold. The flat fee may be discounted for volume, may be a fixed fee for each item regardless of the price of the item, or there may be a graduated series of flat rates for different price ranges of items.

To coordinate the process, a menu of information requests may be provided from the service provider to the user. For example, a master menu may request billing information, order information (about the information or product/services to be researched), a preferred format (for the information retrieved), and delivery/shipping information. Among the billing information requested on the master menu may be included the following: name, address (mailing and/or street address), fax number, phone number, e-mail address, payment method (including choices such as credit card, COD, and check, including a place to enter the credit card type, number, and/or expiration date, if applicable), type of service (e.g. one time, regular, or periodic, including for periodic services, a dollar limit or frequency for the service). The service provider may use a fraud detection program to verify that the user is who the user states the user is.

Among the order information requested about the information to be researched and/or product/service to be ordered or sold, may be the following: a description of the type of information sought, product or service desired, or item or service for which the user desires to solicit customers; a list of key words to be used in the search; the category of information desired; a choice of an unrestricted search or a restricted search, and if restricted, an indication of the sources desired to be searched. Search sources may include but are not limited to: the Internet, newspapers, magazines, books, TV shows, catalogues, newsletters, telephone books. The user may indicate a desired time period during which the search should take place, and/or the search frequency, such as daily, weekly, monthly, annually, or one-time-only.

The user may be asked for the format in which the resulting search information is desired. For example, the user may be asked to fill in the appropriate blanks in the following table:

| Form | Loose/Bound | Number of Copies |
|---|---|---|
| Print | | |
| Disk | n/a | |
| Voice Recording | n/a | |
| Tape | n/a | |

The delivery/shipping information requested regarding how products or information are to be shipped may include a number of choices. For example, for products, the user may choose regular or express mail, courier such as FedEx, or other carrier, such as UPS. For information delivery, the user may choose delivery by phone, voice recording, fax, regular or express mail, courier, other carrier, e-mail, or television, (such as for interactive television users). The user may also be asked to identify the timing or frequency of delivery, such as as soon as possible, daily, weekly, monthly, annually, or some other desired frequency.

One preferred form of the system uses television (TV), which can be supplemented by use of a phone. For a TV system, the system may run a 24-hour menu on a designated TV channel, so that the user turns to the designated channel, and fills out the TV menu to place his or her order using a TV controller. The user may also call a telephone operator for service to assist him or her in filling out the TV master menu. Once the menu has been completed by the user and released to the service provider, the completed menu is sent to researcher(s). The remaining steps after the researcher has received the information are described above.

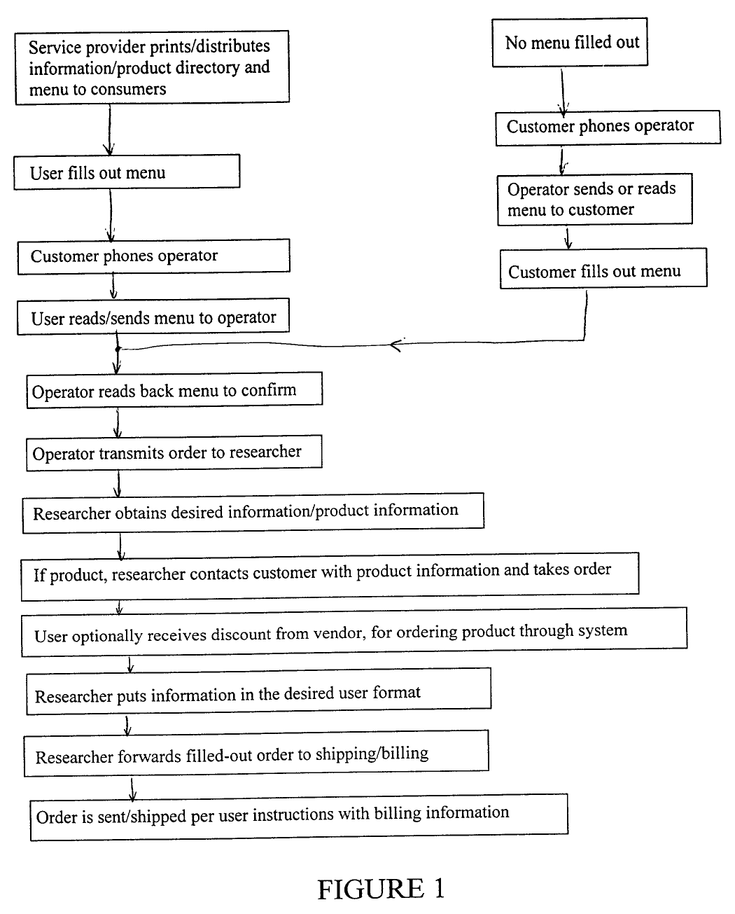

Thus, a preferred form of the of the system/process uses the telephone, computer and/or TV, as shown in FIG. 1. To initiate the service, the user contacts the service provider/system via telephone, computer or television. The system may have an operator or another type of user interface. Telephone contact can be via using a toll-free number or a toll number (such as a 900-number). For a toll number, the user is typically charged for the service based on the time the user is on the phone. The operator can be real or fictitious, such as generated by computer. It the operator is fictitious, the user may have an allotted amount of time to respond to each question in a series of questions asked by the fictitious operator. The user can respond either by vocal response or by using a touch-tone pad on the telephone. Telephone conversations may be recorded for reference/accuracy.

The user fills out the master menu, with help from the operator (if necessary). In addition to or instead of providing the menu live through a series of questions, the service provider may send the user the menu by fax, mail, TV, E-mail, and the like, so that the user may have a hard copy of the menu for reference. Thus, the user may call having already filled out the menu, or may not have a menu at all and may need the menu read by the operator. The user who already has a menu may return the menu by fax, mail, e-mail, and the like rather than using the telephone to call the service provider.

After the service provider receives the filled-out menu (either through a question and answer dialogue or through transmittal of a previously completed menu), the operator or user interface may read back menu data to user for confirmation. The operator/user interface then transmits the order to a researcher. The researcher obtains the desired information. If the research project involves finding a product or service, the service provider then contacts the user with product or service information and takes the user's order. The service provider then purchases the goods or services for the user.

The user may receive a discount from the service provider and/or from the vendor of the product for ordering product through the service provider's system. The researcher or shipping representative of the service provider then puts the gathered information in the desired customer format and/or forwards a filled order to a shipping/billing department of the service provider. The user's order is delivered or shipped per the user's instructions, along with billing information.

The system may use a single means of access, or a combination of two or more. The process can occur with or without human intervention. The system does not require voice recognition, but may use such technology if desired. The system merely requires the user to be able to communicate to the service provider the information desired, or the goods or services desired to be purchased or sold, along with any buying or selling parameters of the goods or services desired or criteria for the information search, and an indication of how much money or time should be spent on the search.

The service provider may optionally choose not to identify the source of the goods or services, but only the price and delivery. This way the searcher has a better chance of assuring being paid for its services rendered. The service provider may also have alliances already established with certain vendors of goods and services or information, and may preferentially search databases only including such vendors before expanding the search.

It should be understood that to the extent that specific examples are described above, the invention is by no means limited to these detailed examples. Those skilled in the art having the benefit of the teachings of the present invention as set forth herein above, can effect numerous modifications thereto. These modifications are to be construed as being encompassed within the scope of the present invention as set forth in the appended claims.

What is claimed:

1. A method for a user to conduct research on an information network, the method comprising the steps of:
(a) the user contacting a service provider having access to the information network;
(b) the user communicating information regarding a desired research project to the service provider;
(c) the service provider conducting the research on the information network and finding one or more results or no results; and
(d) the service provider communicating the results or lack of results to the user.

2. The method of claim 1 wherein the research project comprises obtaining information about a goods or services.

3. The method of claim 2 further comprising:
(e) the user placing an order for the goods or services through the service provider after being provided the results of the research; and
(f) the service provider obtaining the goods or services for the user through the information network.

4. The method of claim 3 wherein the service provider offers the user an incentive for placing the order through the service provider.

5. The method of claim 4 wherein the incentive comprises a discounted price for the goods or services, or bonus points redeemable for value.

6. The method of claim 1 wherein the service provider has a user interface comprising a human operator.

7. The method of claim 1 wherein the service provider has a user interface comprising a computerized interface.

8. The method of claim 1 wherein the user communicates the desired research project to the service provider by responding to a menu of information requests.

9. The method of claim 8 wherein the user contacts the service provider by telephone, the menu of information requests is audibly communicated to the user, and the user's responses to the menu are in the form of selected telephone touch-tone entries on vocalized answers.

10. The method of claim 8 wherein the menu is posted on a television channel.

11. The method of claim 10 where the user responds to the menu through an interactive television using a television controller.

12. The method of claim 10 where the user responds to the menu by telephone.

13. The method of claim 8 wherein the menu is posted on a computer site accessible to the user and the user responds to the menu via computer.

14. The method of claim 1 wherein the user places a telephone call to the service provider and the service provider bills the user based upon duration of the telephone call.

15. The method of claim 1 further comprising the service provider billing the user for services based upon an amount of research time expended.

16. The method of claim 3 further comprising the service provider billing the user a percentage of an acquisition price of the goods or services.

17. The method of claim 1 further comprising the service provider billing the user for formatting, packaging, copying, shipping, or a combination thereof.

18. The method of claim 1 wherein the information regarding the research project includes information from the group consisting of: billing information; key words for use in the research; a description of a desired product or service; one or more sources desired to be searched; a time period during which the research is desired to be conducted; a search frequency; a format in which the results of the research are desired; delivery or shipping information; and any combination thereof.

19. The method of claim 1 further comprising the service provider performing a fraud detection step to verify the user's identity.

20. The method of claim 1 wherein the information network comprises a global computer information network.

21. The method of claim 1 wherein the service provider has a user interface, at least one researcher, at least one shipper, the method comprising the user interface receiving the information regarding the desired research project from the user and transmitting the information to the researcher, the researcher performing the research, attaining a result, and transmitting the result to the shipper, and the shipper delivering the result to the user.

22. The method of claim 2 wherein the service provider does not include an identification of any source of the goods or services in the results communicated to the user in step (d).

23. A method for a user to solicit customers for goods or services on an information network, the method comprising the steps of:
(a) the user contacting a service provider having access to the information network;
(b) the user communicating information regarding the goods or services to the service provider;
(c) the service provider posting on the information network a solicitation for customers for the goods or services and receiving one or more responses or no response to the solicitation; and
(d) the service provider communicating the responses or lack of responses to the user.

24. A system to enable a user to indirectly conduct research, solicit customers for goods or services, or acquire goods or services, via an information network, the system comprising:
a service provider having access to the information network and an interface accessible to the user;
a menu of one or more information requests communicable to the user by the service provider;
means for receiving responses from the user to the menu of information requests; and
means for notifying the user of results of the research, notifying the user about customers found for the goods or services, or delivering the goods or services.

25. The system of claim 24 wherein the method comprises shopping for goods or services and the system further comprises means for accepting an order from the user for goods or services, means for placing the order with a third party, and means for arranging shipping or delivery of the goods or services.
